(19) United States
(12) Patent Application Publication
(10) Pub. No.: US 2006/0095267 A1
(43) Pub. Date: May 4, 2006

(54) Dialogue system, dialogue method, and recording medium

(75) Inventors: Ai Yano, Kawasaki (JP); Tatsuro Matsumoto, Kawasaki (JP); Kazuo Sasaki, Kawasaki (JP); Satoru Watanabe, Kawasaki (JP); Masayuki Fukui, Kawasaki (JP); Yasuhide Matsumoto, Kawasaki (JP); Hideto Kihara, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/088,989

(22) Filed: Mar. 24, 2005

(30) Foreign Application Priority Data
Oct. 28, 2004 (JP) 2004-314634

(51) Int. Cl. G10L 21/00

(52) U.S. Cl. 704/275

(57) ABSTRACT

A dialogue system, a dialogue method, and a recording medium storing a computer program are provided for allowing a third party to assist effectively a plurality of dialogues, without causing a sense of discomfort to the users. In a dialogue system for performing automatic answering to a voice, a dialogue assistance apparatus is provided that is connected in a state permitting transmission and reception of data. The dialogue assistance apparatus performs the following operations of: suspending a dialogue when the dialogue is not established meaningfully; displaying a plurality of recognition candidates for an utterance received last in the dialogue suspended by the dialogue suspending means; receiving one recognition candidate selected from a plurality of the candidates; and sending out the selected candidate. When the one candidate is received from the dialogue assistance apparatus, the dialogue is resumed according to the dialogue scenario information starting at the portion having been suspended.

### CROSS-REFERENCE TO RELATED APPLICATIONS

This Nonprovisional application claims priority under 35 U.S.C.§119(a) on Patent Application No. 2004-314634 filed in Japan on Oct. 28, 2004, the entire contents of which are hereby incorporated by reference.

### BACKGROUND OF THE INVENTION

The present invention relates to a dialogue system, a dialogue method, and a recording medium which allow a third party to assist a dialogue carried out between a user and a computer automatically according to dialogue scenario information, such that the dialogue should advance smoothly.

In recent years, voice dialogue systems are spreading widely. Such systems, which are referred to as IVR (Interactive Voice Response) systems in some cases, employ speech recognition (ASR: Auto Speech Recognition) and are used in voice portal sites and the like. Such voice dialogue systems permit various services such as a ticket reservation service and a parcel re-delivery request service, without deploying personnel in every service base. This provides great merits such as the realization of 24-hour services and the reduction of personnel expenses.

On the other hand, such automatic response is performed depending on voices uttered by users. Thus, for the purpose of advancing smooth dialogues, accurate speech recognition is an important issue. Nevertheless, even if accuracy in the speech recognition could improved much further, misrecognition of input voices is difficult to be eliminated completely. In case of misrecognition, a dialogue could go into a repetition loop, and becomes impossible to advance. Alternatively, the dialogue could advance in a direction completely different from user's expectation. As such, there has been a problem that a dialogue could not advance smoothly.

In order to resolve the problem, Japanese Patent Application Laid-Open No.2000-048038 discloses a voice dialogue system in which when it is detected that no voice is uttered from a user for a predetermined time, the dialogue is advanced according to a assistance scenario prepared in advance.

Further, in another voice dialogue system disclosed in Japanese Patent Application Laid-Open No.2002-202882, the degree of progress of a dialogue is calculated on the basis of a dialogue scenario. Then, when the degree of dialogue progress is lower than a predetermined threshold, dialogue assistance is performed such that a third party renews the contents of the dialogue, or that a third party enters the dialogue so as to change it into a three-person dialogue including the user, or that a third party and the user carry out a dialogue, or the like.

### BRIEF SUMMARY OF THE INVENTION

An object of the invention is to provide a dialogue system, a dialogue method, and a computer program for allowing a third party to assist effectively a plurality of dialogues, without causing a sense of discomfort to users.

In order to achieve this object, a dialogue system according to a first invention is a dialogue system comprising: means for receiving an utterance; means for recognizing the received utterance; means for advancing a dialogue on the basis of the recognized result and dialogue scenario information which describes a procedure for advancing the dialogue; and means for outputting a response to said received utterance; wherein the system comprises a dialogue assistance apparatus connected in a state permitting transmission and reception of data via communication means, and the dialogue assistance apparatus comprises: dialogue establishment judging means for judging whether the dialogue is established meaningfully or not; dialogue suspending means for suspending said dialogue when the dialogue establishment judging means judges that said dialogue is not established meaningfully; means for displaying a plurality of recognition candidates for an utterance received last in the dialogue suspended by the dialogue suspending means; means for receiving one recognition candidate selected from a plurality of said recognition candidates displayed by the means; and means for sending out the received one recognition candidate; and wherein the system further comprises means for resuming the dialogue according to said dialogue scenario information starting at the portion having been suspended, when said one recognition candidate is received from said dialogue assistance apparatus.

A dialogue system according to a second invention is characterized in that in the first invention, the dialogue establishment judging means comprises: dialogue history storage means for storing a state transition history of a dialogue based on said dialogue scenario information; and misrecognition judging means for judging whether said received utterance has been recognized incorrectly or not on the basis of said recognized result and said state transition history.

A dialogue system according to a third invention is characterized in that in the first or second invention, a plurality of dialogues are on going on the basis of a plural pieces of said dialogue scenario information, and in that provided are: means for calculating a degree of dialogue progress which indicates a degree of progress of each of said dialogues; and priority calculating means for calculating a priority for each of said dialogues on the basis of a condition including said degree of dialogue progress.

A dialogue method according to a fourth invention is a dialogue method in which a computer performs the steps of receiving an utterance; recognizing the received utterance; advancing a dialogue on the basis of the recognized result and dialogue scenario information which describes a procedure for advancing the dialogue; outputting a response to said received utterance; wherein said computer performs the following steps of: judging whether the dialogue is established meaningfully or not; suspending said dialogue when it is judged that said dialogue is not established meaningfully; displaying a plurality of recognition candidates for an utterance received last in the dialogue suspended by the dialogue suspending means; receiving one recognition candidate selected from a plurality of said displayed recognition candidates; and resuming the dialogue according to said dialogue scenario information starting at the portion having been suspended, when said one recognition candidate is received.

A recording medium according to a fifth invention which stores a computer program is a recording medium storing a computer program capable of being executed on another computer connected to a dialogue system in which a computer performs the steps of: receiving an utterance; recognizing the received utterance; advancing a dialogue on the basis of the recognized result and dialogue scenario information which describes a procedure for advancing the dialogue; outputting a response to said received utterance; wherein the computer program causes said another computer to serve as dialogue establishment judging means for judging whether the dialogue is established meaningfully or not; dialogue suspending means for suspending said dialogue when the dialogue establishment judging means judges that said dialogue is not established meaningfully; means for displaying a plurality of recognition candidates for an utterance received last in the dialogue suspended by the dialogue suspending means; means for receiving one recognition candidate selected from a plurality of said recognition candidates displayed by the means; and means for sending out the received one recognition candidate.

According to the first, the fourth, and the fifth inventions, in the dialogue system for performing automatic answering, when a dialogue is not established meaningfully, the dialogue is suspended. Thus, a plurality of recognition candidates for an utterance received last in the suspended dialogue are displayed. Then, one recognition candidate is selected from a plurality of the recognition candidates so that the dialogue should advance. Then, the dialogue is resumed according to dialogue scenario information starting at the portion having been suspended. Accordingly, when an operator or the like serving as a third party finds stagnation in a dialogue performed between a user and the system, an error in the recognition for the utterance generated immediately before the user has suspended the dialogue can be corrected. Thus, on the basis of the correct recognition result, the dialogue can be resumed according to the dialogue scenario.

According to the second invention, a state transition history of a dialogue is stored on the basis of dialogue scenario information. In addition to the judgment of misrecognition or not based on the result of recognition, the state transition history also is used in the judgment whether any abnormality occurs or not such as whether a dialogue according to dialogue scenario information is in a looped state or not. On the basis of this result, judgment is made whether the received utterance has been recognized incorrectly. Accordingly, even when it is difficult to clearly judge that the recognition is mistaken, it can be detected whether the dialogue is stagnating or not, on the basis of the state transition history of the dialogue. This permits more accurate judgment whether the dialogue is advancing or not between a user and the dialogue system.

According to the third invention, in a state that a plurality of dialogues are advancing on the basis of a plural pieces of dialogue scenario information, the degree of dialogue progress which indicates the degree of the progress of each dialogue is calculated. Then, on the basis of a condition including the degree of dialogue progress, a priority is calculated for each dialogue. Accordingly, assistance can be performed in the descending order of priority of the dialogues. This allows operators in a number smaller than the number of dialogues to assist the dialogues effectively.

According to the first, the fourth, and the fifth invention, when an operator or the like serving as a third party finds stagnation in a dialogue performed between a user and the system, an error in the recognition for the utterance generated immediately before the user has suspended the dialogue can be corrected. Thus, on the basis of the correct recognition result, the dialogue can be resumed according to the dialogue scenario. This prevents the operator from being restrained to a single dialogue, and allows the operator to assist stagnated dialogues solely so as to correct the misrecognition. This permits easy restoration of the dialogue into line with the dialogue scenario, and hence allows the dialogue to advance effectively without a sense of discomfort to users.

According to the second invention, even when it is difficult to clearly judge that the recognition is mistaken, it can be detected whether the dialogue is stagnating or not, on the basis of the state transition history of the dialogue. This permits more accurate judgment whether the dialogue is advancing or not between a user and the dialogue system.

According to the third invention, assistance can be performed in the descending order of priority of the dialogues. This allows operators in a number smaller than the number of dialogues to assist stagnated dialogues effectively.

The above and further objects and features of the invention will more fully be apparent from the following detailed description with accompanying drawings.

### BRIEF DESCRIPTION OF THE SEVERAL VIEWS OF THE DRAWINGS

FIG. 1 is a block diagram showing the configuration of a voice dialogue system according to Embodiment 1 of the invention.

FIG. 2 is a block diagram showing the configuration of an automatic answering system of a voice dialogue system according to Embodiment 1 of the invention.

FIG. 3 is a flow chart showing a procedure of a CPU of a dialogue assistance apparatus of a voice dialogue system according to Embodiment 1 of the invention.

FIG. 4 is a diagram illustrating state transitions in a dialogue scenario for checking a name.

FIG. 5 is a diagram illustrating a dialogue monitor screen for displaying a dialogue state.

FIG. 6 is a diagram illustrating a dialogue assistance screen for restoring a dialogue.

FIG. 7 is a diagram illustrating state transitions in a dialogue scenario for the purchase of a ticket.

FIG. 8 is a diagram illustrating another example of a dialogue monitor screen for displaying a dialogue state in the case that a degree of progress of a dialogue is judged and displayed.

FIG. 9 is a flow chart showing a procedure of a CPU of a dialogue assistance apparatus of a voice dialogue system according to Embodiment 1 of the invention.

FIG. 10 is a flow chart showing a procedure of a CPU of a dialogue assistance apparatus of a voice dialogue system according to Embodiment 2 of the invention.

FIG. 11 is a block diagram showing the configuration of a voice dialogue system according to Embodiment 3 of the invention.

### DETAILED DESCRIPTION OF THE INVENTION

In the voice dialogue system disclosed in JP-A-2000-048038, the state of dialogue progress is judged on the basis of the presence or absence of the input of a voice uttered by the user. Thus, this system cannot detect a repeated dialogue caused by misrecognition, a dialogue guided in a direction different from the user's intention, or the like. Further, the dialogue scenario for the assistance needs to be prepared with considering all cases. This causes a problem that the preparation of the dialogue scenarios in actual installation becomes more difficult.

In the voice dialogue system disclosed in JP-A-2002-202882, a third party for assisting a dialogue performs dialogue assistance by means of directly inputting a voice. This human-to-human dialogue guides the original dialogue into line with a dialogue scenario. Further, no misrecognition occurs for the voice uttered by the user. Nevertheless, the third party needs to continue the assistance until the dialogue scenario is completed. Thus, in case of a plurality of users, it is difficult to deploy such assisting third parties in the number of users. Thus, there has been a problem that a user in a stagnated dialogue cannot be assisted in some cases.

Further, when the dialogue with the voice dialogue system is switched to a direct dialogue with a third party, a problem occurs that a sense of discomfort arise to the user in the dialogue.

The invention has been devised with considering these situations. An object of the invention is to provide a dialogue system, a dialogue method, and a computer program for allowing a third party to assist effectively a plurality of dialogues, without causing a sense of discomfort to the users. The invention is realized in the following embodiments.

### EMBODIMENT 1

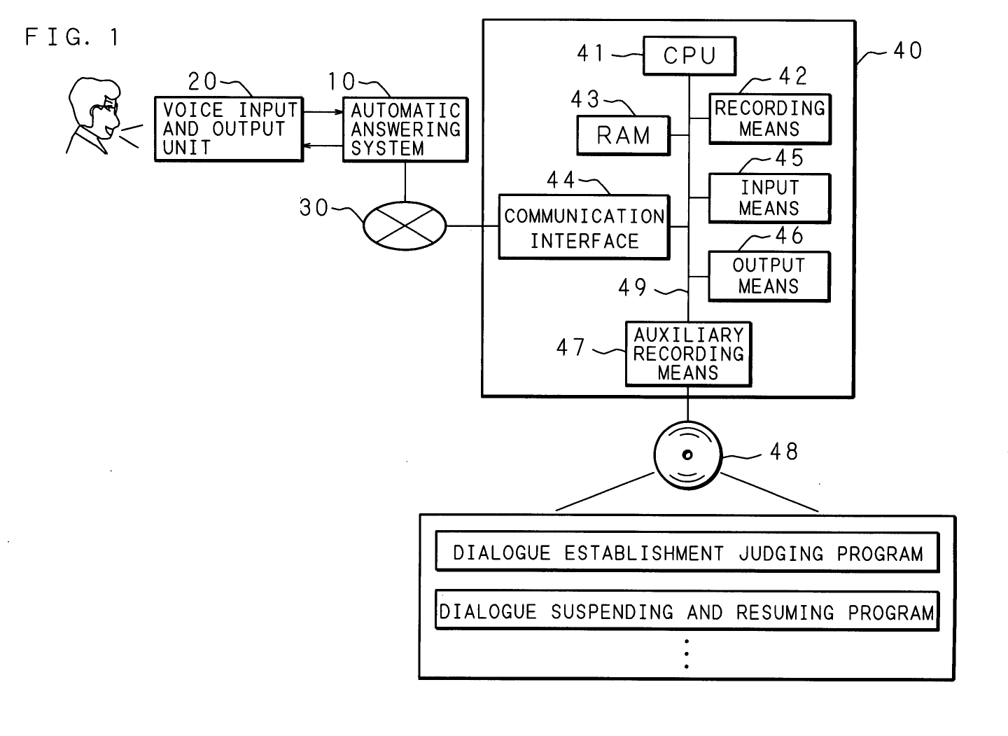

A dialogue system according to Embodiment 1 of the invention is described below in detail with reference to the drawings. In this embodiment, a voice dialogue system is described as an example. FIG. 1 is a block diagram showing the configuration of a voice dialogue system according to Embodiment 1 of the invention. As shown in FIG. 1, a voice dialogue system according to Embodiment 1 comprises: an automatic answering system 10 provided with a voice input and output unit 20 for receiving a voice uttered by a user and outputting an answer voice to the user; and a dialogue assistance apparatus 40 connected via a network 30 such as the Internet.

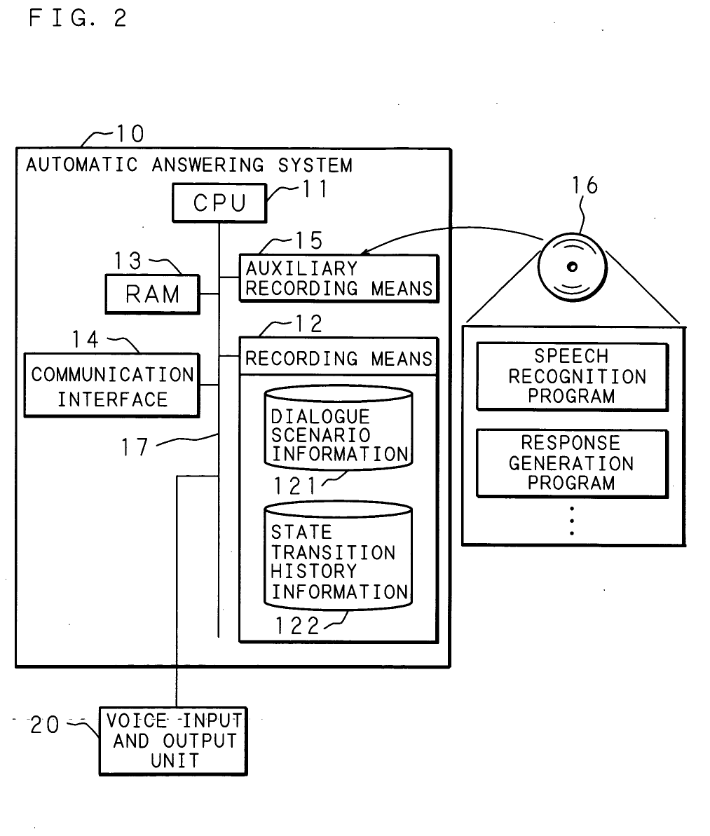

FIG. 2 is a block diagram showing the configuration of the automatic answering system 10 of the voice dialogue system according to Embodiment 1 of the invention. The automatic answering system 10 comprises at least: a CPU (central processing unit) 11; recording means 12; a RAM 13; a communication interface 14 connected to external communication means such as the network 30; and auxiliary recording means 15 employing a portable recording media 16 such as a DVD and a CD.

The CPU 11 is connected to each part of the above-mentioned hardware of the automatic answering system 10 via an internal bus 17, and thereby controls each part of the above-mentioned hardware. Then, the CPU 11 performs various software functions according to processing programs recorded in the recording means 12. These programs include: a program for receiving a voice uttered by a user and then performing speech recognition; a program for reading dialogue scenario information and thereby generating a response; and a program for reproducing and outputting the generated response.

The recording means 12 is composed of a built-in fixed mount type recording unit (hard disk), a ROM, or the like. The recording means stores the processing programs necessary for the function of the automatic answering system 10 which are acquired from a computer in the outside via the communication interface 14, or from the portable recording media 16 such as a DVD and a CD-ROM. In addition to the processing programs, the recording means 12 records also: dialogue scenario information 121 which describes a dialogue scenario for performing automatic answering; state transition history information 122 which is history information concerning state transitions of a dialogue according to the dialogue scenario; and the like.

The RAM 13 is composed of a DRAM or the like, and records temporary data generated in the execution of the software. The communication interface 14 is connected to the internal bus 17 in a manner permitting communication with the network 30. Thus, data necessary for the processing can be transmitted to and received from the dialogue assistance apparatus 40 described later.

The voice input and output unit 20 has: the function of receiving a voice uttered by a user through an audio input device such as a microphone and then converting the voice into voice data so as to send the data to the CPU 11; and the function of reproducing and outputting a synthesized speech corresponding to a generated response through an audio output device such as a speaker, in response to an instruction of the CPU 11.

The auxiliary recording means 15 employs the portable recording media 16 such as a CD and a DVD, and thereby downloads into the recording means 12 the programs, the data, and the like to be processed by the CPU 11. Further, data processed by the CPU 11 can be written and backed up into the auxiliary recording means.

The network 30 is connected to a plurality of automatic answering systems 10, 10, . . . as well as the dialogue assistance apparatus 40 for assisting dialogues performed in the automatic answering systems 10, 10, . . . . Embodiment 1 is described for the case that a plurality of the automatic answering systems 10, 10, . . . and the dialogue assistance apparatus 40 are composed of physically separate computers. However, the invention is not limited to this configuration. A computer constituting one of the automatic answering systems 10 may serve also as the dialogue assistance apparatus 40.

As shown in FIG. 1, a dialogue assistance apparatus 40 of a voice dialogue system according to Embodiment 1 of the invention comprises at least: a CPU (central processing unit) 41; recording means 42; a RAM 43; a communication interface 44 connected to external communication means such as a network 30; input means 45; output means 46; and auxiliary recording means 47 employing a portable recording media 48 such as a DVD and a CD.

The CPU 41 is connected to each part of the above-mentioned hardware of the dialogue assistance apparatus 40 via an internal bus 49, and thereby controls each part of the above-mentioned hardware. Then, the CPU 41 performs various software functions according to processing programs recorded in the recording means 42. These programs include: a program for judging whether a dialogue is established meaningfully or not; a program for suspending or resuming the dialogue; and a program for displaying a plurality of recognition candidates for the voice input last in the suspended dialogue, and then receiving a selection.

The recording means 42 is composed of a built-in fixed mount type recording unit (hard disk), a ROM, or the like. The recording means stores the processing programs necessary for the function of the dialogue assistance apparatus 40 which are acquired from a computer in the outside via the communication interface 44, or from the portable recording media 48 such as a DVD and a CD-ROM.

The RAM 43 is composed of a DRAM or the like, and records temporary data generated in the execution of the software. The communication interface 44 is connected to the internal bus 49 in a manner permitting communication with the network 30. Thus, data necessary for the processing can be transmitted and received.

The input means 45 is a pointing device such as a mouse for selecting information displayed on a screen, or a keyboard for inputting text data on the screen by means of key stroke, or the like. The output means 46 is a display device for displaying and outputting images such as a liquid crystal display (LCD) and a display unit (CRT).

The auxiliary recording means 47 employs the portable recording media 48 such as a CD and a DVD, and thereby downloads into the recording means 42 the programs, the data, and the like to be processed by the CPU 41. Further, data processed by the CPU 41 can be written and backed up into the auxiliary recording means.

In order to prompt a speaking person to make an utterance, the automatic answering system 10 of the voice dialogue system according to Embodiment 1 of the invention outputs a voice through the voice input and output unit 20 according to the dialogue scenario information 121 stored in the recording means 12, in response to an instruction of the CPU 11. For example, a question such as “Which is your business, ∘∘, xx, or . . . ?” is output in a voice. This question restricts the range of the next utterance to be input by the speaking person.

The dialogue scenario information 121 is described in VoiceXML (VXML, hereafter) scenario description language or the like which permits the reception of a voice uttered in the dialogue. That is, the dialogue scenario information 121 describes: the contents of the output from the computer; the transition of the dialogue in response to the uttered voice; the process to be performed next in response to the contents of the uttered voice; and the like.

When a voice uttered in response to the output voice is input through the voice input and output unit 20, the input voice is stored as waveform data or as data indicating the utterance characteristic quantity which is the result of acoustic analysis of the input voice, into the recording means 12 and the RAM 13. In response to an instruction of the CPU 11, speech recognition is performed on the voice stored in the RAM 13. The speech recognition engine used in this speech recognition process is not limited to a specific one. Any speech recognition engine generally used may be used. The speech recognition result is stored in the recording means 12 and the RAM 13.

The recording means 12 is not limited to a built-in hard disk. Any recording medium capable of storing mass data may be used, such as a hard disk built in another computer connected via the communication interface 14.

On the basis of the stored speech recognition result, according to the dialogue scenario information 121, the CPU 11 generates a system utterance serving as a response to the received voice, and then sends the utterance to the voice input and output unit 20. The voice input and output unit 20 reproduces and outputs the system utterance as a synthesized speech. The user performs the dialogue with the automatic answering system 10 according to the dialogue scenario information 121, while the CPU 11 records the speech recognition result of the received voice and the contents of the system utterance into the recording means 12, as the state transition history information 122.

In the recording of the speech recognition result of the received voice and the contents of the system utterance into the recording means 12 as state transition history information 122, the recording is not limited to that the entirety of the data is recorded from the start of a dialogue according to the dialogue scenario information 121 to its end. It is not limited. For example, the recording of the state transition history information 122 may be started at the time of detecting a dialogue error. Further, the recording of the state transition history information 122 may be continued until the dialogue is completed, or until the progress of the dialogue goes into line with the dialogue scenario information 121, or until the operator instructs the termination of the recording.

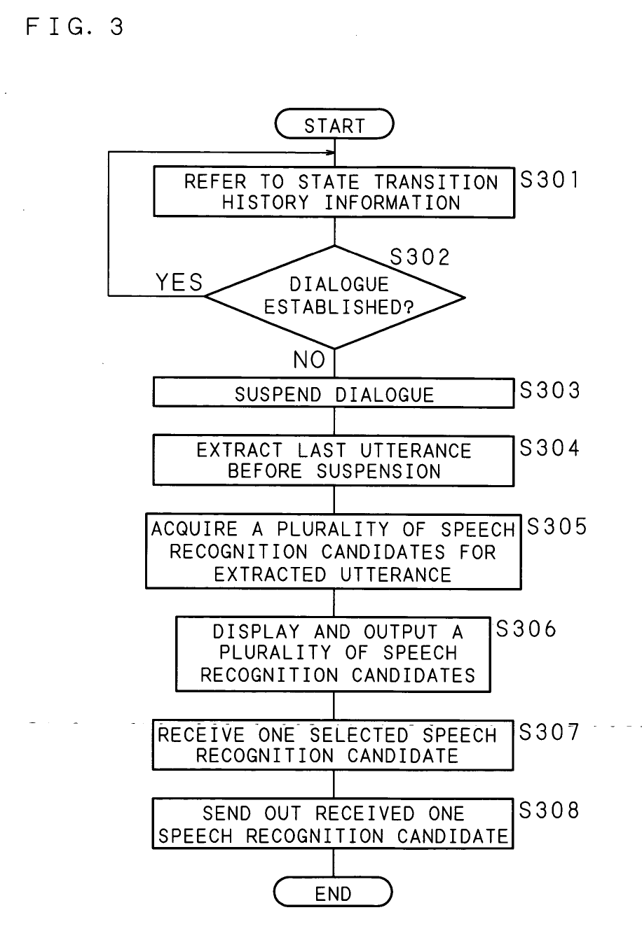

The dialogue assistance apparatus 40 monitors the above-mentioned dialogue between the user and the automatic answering system 10. When judging that the dialogue is stagnating, the dialogue assistance apparatus assists the dialogue by means of intervention by an operator serving as a third party. FIG. 3 is a flow chart showing a procedure of the CPU 41 of the dialogue assistance apparatus 40 of the voice dialogue system according to Embodiment 1 of the invention.

The CPU 41 of the dialogue assistance apparatus 40 is connected to the automatic answering system 10 via the network 30 in a state permitting the transmission and the reception of data. The CPU 41 refers to the state transition history information 122 recorded in the recording means 12 of the automatic answering system 10 (Step S301), and thereby judges whether the dialogue between the user and the automatic answering system 10 is established meaningfully or not (Step S302). When the CPU 41 judges that the dialogue between the user and the automatic answering system 10 is not established meaningfully (Step S302: NO), the CPU 41 suspends the dialogue between the user and the automatic answering system 10 (Step S303). Specifically, the CPU 41 suspends the reception of a voice uttered by the user and the generation of a system utterance in the automatic answering system 10.

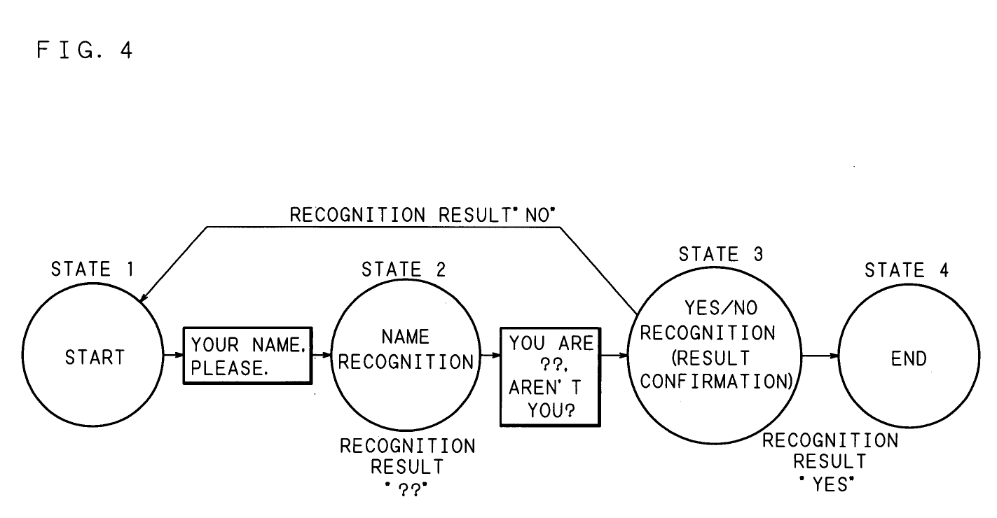

In Embodiment 1, the state transition history of the dialogue based on the dialogue scenario information is stored in the recording means 12 or the RAM 13. Then, on the basis of the state transition history information 122 stored in the recording means 12 of the automatic answering system 10, it is judged whether the input voice has been recognized correctly or not. FIG. 4 is a diagram illustrating the state transitions in a dialogue scenario for checking a name. As shown in FIG. 4, this dialogue scenario begins in State 1. Then, a system utterance “Your name, please” is output. Then, the state transits to State 2.

In State 2, speech recognition is performed on the input voice so that the speech recognition result is stored into the RAM 13. When the stored speech recognition result is “∘∘”, in this dialogue scenario, a system utterance “You are ∘∘, aren't you?” is output, and then the state transits to State 3.

In State 3, an input voice undergoes speech recognition so that the speech recognition result is stored into the RAM 13. In State 3, the speech recognition result is expected to be the alternative of “Yes” or “No”. Thus, a high reliability is obtained in the speech recognition result in State 3. When the stored speech recognition result is “Yes”, the state transits to State 4 so that the dialogue scenario is completed. At that time, the speech recognition result in State 2 is judged to be correct.

The CPU 41 extracts a voice received last in a suspended dialogue, from the state transition history information 122 (Step S304), and then acquires a plurality of speech recognition candidates corresponding to the extracted voice (Step S305). The CPU 41 classifies a plurality of the acquired speech recognition candidates, for example, in the order of evaluation values calculated in the speech recognition, and then displays the candidates on the output means (Step S306).

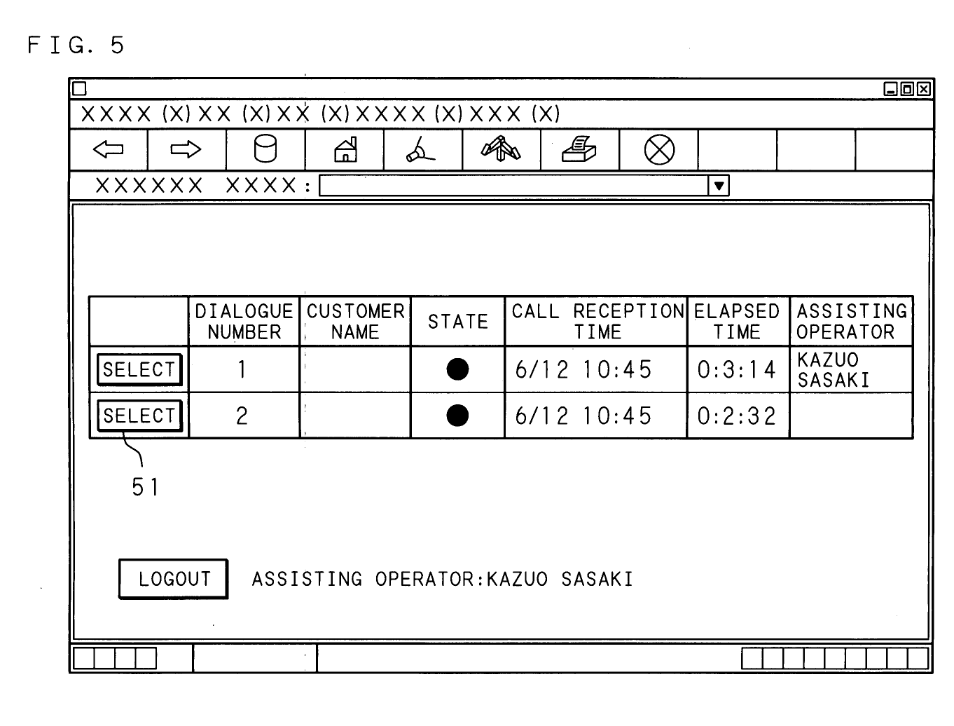

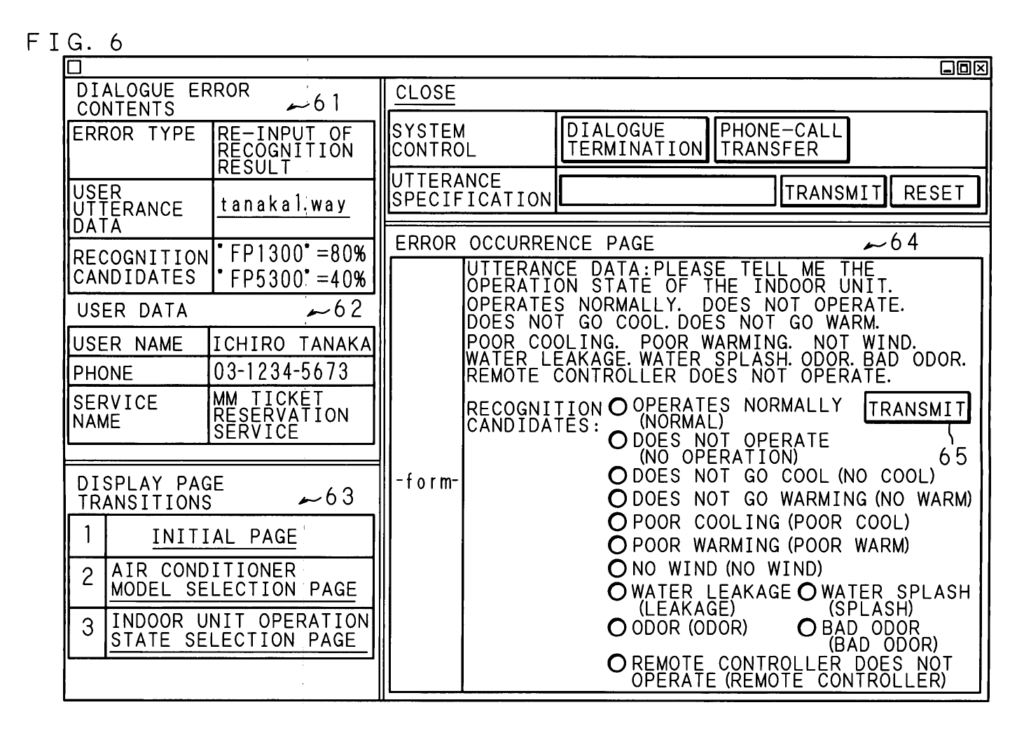

FIGS. 5 and 6 are diagrams each illustrating a display screen of the dialogue assistance apparatus 40 of the voice dialogue system according to Embodiment 1 of the invention. FIG. 5 is a diagram illustrating a dialogue monitor screen for displaying a dialogue state. FIG. 6 is a diagram illustrating a dialogue assistance screen for restoring a dialogue.

As shown in FIG. 5, dialogues performed between users and the automatic answering system 10 are displayed such that the state of each dialogue is shown with a number for identifying the dialogue. Specifically, displayed are: the name of each customer in dialogue execution; the state of the dialogue; the start time of the dialogue; the elapsed time after the dialogue start; and the like. The state of a dialogue is discriminated with a displayed color. For example, when a dialogue is performed normally, the dialogue is displayed in blue. When the progress of a dialogue is slow, the dialogue is displayed in yellow. When a dialogue is stagnating, the dialogue is displayed in red. As such, visual confirmation of the state of the dialogues is achieved.

In case that the automatic answering system is a voice answering system as in Embodiment 1, the dialogue scenario is described in VXML. When an error situation of a page or the like recognized to have a dialogue error occurrence is to be presented to the operator, the presentation is output in a voice alone if the description of the dialogue scenario is solely given. That is, the candidates for the contents of the response expected in the dialogue scenario cannot be recognized visually. Thus, in order that the operator can visually recognize the error situation and the like, the contents of the dialogue scenario described in VXML is converted into HTML. In this case, the conversion and the presentation are preferably performed such that the contents of the utterance generated according to the dialogue scenario by the automatic answering system 10 and the candidates for the contents of the response to the utterance are distinguishable.

In the dialogue assistance screen of FIG. 6, the contents of the utterance of the automatic answering system 10 and the contents of the response expected in the dialogue scenario are extracted from the described contents of the page of the dialogue scenario, and then embedded respectively in the HTML sentences describing the display contents to be output to the display unit to the operator. For the purpose of reducing the operator's work, the candidates for the contents of the response are preferably processed such as to allow the operator to select one. Further, when recognition syntax information is used in addition to the dialogue scenario information 121, the candidates for the contents of the response can be specified more securely. The candidates described in the recognition syntax information may be presented as selection candidates in the intact order described originally. Alternatively, the candidates may be presented in the descending order of recognition rate. Further, the candidates may be sorted and presented in the order of the Japanese syllabary, or in the alphabetical order, or the like. Furthermore, the candidates may be sorted or merged and presented on the basis of the value to be returned as the recognition result.

As such, when the dialogue mode between the automatic answering system 10 and the user is different from the dialogue mode of the assisting operator, the data format is converted such as to resolve the difference in the dialogue mode. This improves the multiplicity of the dialogue assistance of the operator.

The dialogue monitor screen of FIG. 5 is provided with selection buttons 51 each for selecting to start dialogue assistance for a dialogue number. When the operator selects a selection button 51, the screen transits to a dialogue assistance screen. At that time, when the operator selects the selection button 51, a message “Please wait for a while” is preferably output to the user of the selected dialogue. This allows the user to recognize that the user is under dialogue assistance. Thus, even when the response takes time, reliability is maintained with the user.

Similarly, the case that the dialogue is performed solely with the automatic answering system 10 and the case that an operator assists the dialogue are preferably distinguishable to the user of the dialogue by means of a change in the output form such as a voice change, a color or font change in the text display, and the like. This reduces a sense of discomfort which could easily occur in dialogue assistance by an operator.

The invention is not limited to that the operator intentionally selects a dialogue which needs dialogue assistance. A selection condition may be set up depending on the situation of dialogue errors so that the dialogue system may assign an operator to a dialogue on which dialogue assistance is to be performed. For example, when the degree of urgency of a dialogue error is high, an operator presently not assisting a dialogue may be assigned to the dialogue with high priority. Alternatively, an operator expected to complete the present dialogue assistance soon may be assigns. Such determination is more preferably performed by the dialogue system. Further, an operator who should perform assistance may be assigned in advance depending on the line number.

As shown in FIG. 6, the dialogue assistance screen comprises: a dialogue error contents display area 61 for displaying the factor causing the state of the dialogue to go into yellow display or red display; a user data display area 62 for displaying the information concerning the user of the dialogue; a display page transition display area 63 for displaying the transition of the display pages in the dialogue scenario information 121; and an error occurrence page display area 64 composed of a page contents display area for displaying the contents of the page in which the dialogue error occurrence has been recognized and a speech recognition result specification area for displaying candidates for the correct speech recognition result in a state permitting selection so as to normalize the dialogue. On the basis of the information displayed in the dialogue error contents display area 61, the user data display area 62, and the display page transition display area 63, the operator selects one appropriate speech recognition result from a plurality of the speech recognition candidates displayed in the speech recognition result specification area of the error occurrence page display area 64. The selected speech recognition candidate is transmitted as the corrected speech recognition result to the automatic answering system 10 at the time of the selection of the transmission button 65.

As for the information displayed in the dialogue error contents display area 61, the user data display area 62, and the display page transition display area 63, the displayed information changes successively depending on the response to the question so that the process should transit to a predetermined one. Thus, the history reaching the page of the dialogue error occurrence is understood clearly. This permits effective assistance in comparison with the case that the contents of the error occurrence page is solely displayed.

In FIG. 6, solely one set of utterance contents and response candidates is described in the page in which a dialogue error occurrence has been recognized. However, plural sets of utterance contents and response candidates may be described in the page in which a dialogue error occurrence has been recognized. In this case, in order that each set of utterance contents causing a dialogue error and its response candidates should easily be specified, the colors of the characters and the background of the corresponding portion are preferably changed. Alternatively, the font, the size, or the like of the characters may be changed. Further, the contents may be displayed starting from the beginning of the corresponding portion, in the error occurrence page display area 64.

Further, when the size of the description of the page of the dialogue error occurrence exceeds a predetermined value, especially when the size is excessively large, the corresponding portion may solely be extracted so that a list of the error occurrence portion and the recognition result candidates may be generated. Then, the corresponding portion may solely be displayed in the error occurrence page area 64.

The CPU 41 receives one speech recognition candidate selected from a plurality of the displayed speech recognition candidates (Step S307), and then sends the received one speech recognition candidate to the automatic answering system 10 of the suspended dialogue (Step S308).

The automatic answering system 10 having received the one speech recognition candidate generates a system utterance as a system utterance generated according to the dialogue scenario information 121 to the user and as a response to the received one speech recognition candidate. Then, the automatic answering system sends the system utterance to the voice input and output unit 20. The voice input and output unit 20 reproduces and outputs the system utterance as a synthesized speech.

Accordingly, the user judges that a system utterance expected in the dialogue scenario information has been made. Thus, in a state that the misrecognition of the uttered voice is corrected, the user can continue the dialogue with the voice dialogue system without a sense of discomfort.

The invention is not limited to that the dialogue assistance by the operator is terminated at the time when the operator selects a candidate for the contents of the response and then sends the candidate to the automatic answering system 10. For example, the dialogue assistance may be terminated at the time when the page display is changed. Alternatively, the termination may be carried out at the time when the dialogue assistance screen is closed, or when the operator oneself instructs the termination of the dialogue assistance, or when the dialogue error has been resolved, or when a predetermined time has elapsed after the dialogue error was resolved.

In the description given above, on the basis of the state transition history information 122 recorded in the recording means 12 of the automatic answering system 10, it has been judged whether the input voice has been recognized correctly or not. Then, on the basis of the result of this judgment, it has been judged whether the dialogue is established meaningfully or not. However, the method for judging whether the dialogue is established meaningfully or not is not limited to this. For example, the dialogue scenario is prepared on the assumption that the dialogue between the user and the automatic answering system 10 would advance according to a dialogue flow (sequence) expected in advance. Thus, in the case that the dialogue between the user and the automatic answering system 10 advances according to the flow of the dialogue expected in advance, the state transition of the dialogue occurs differently from that of the case that the expectation does not hold. Thus, the method used for judging whether the dialogue is established meaningfully or not may be a method where the judgment whether the dialogue situation is normal or not is carried out on the basis the transition state of the dialogue. For example, it may be judged whether the same dialogue is repeated (transitions in a series of the same pages are repeated) or not. Alternatively, it may be judged whether the dialogue is advancing in a direction not expected (a page transition occurs differently from the expected flow of the dialogue) or not.

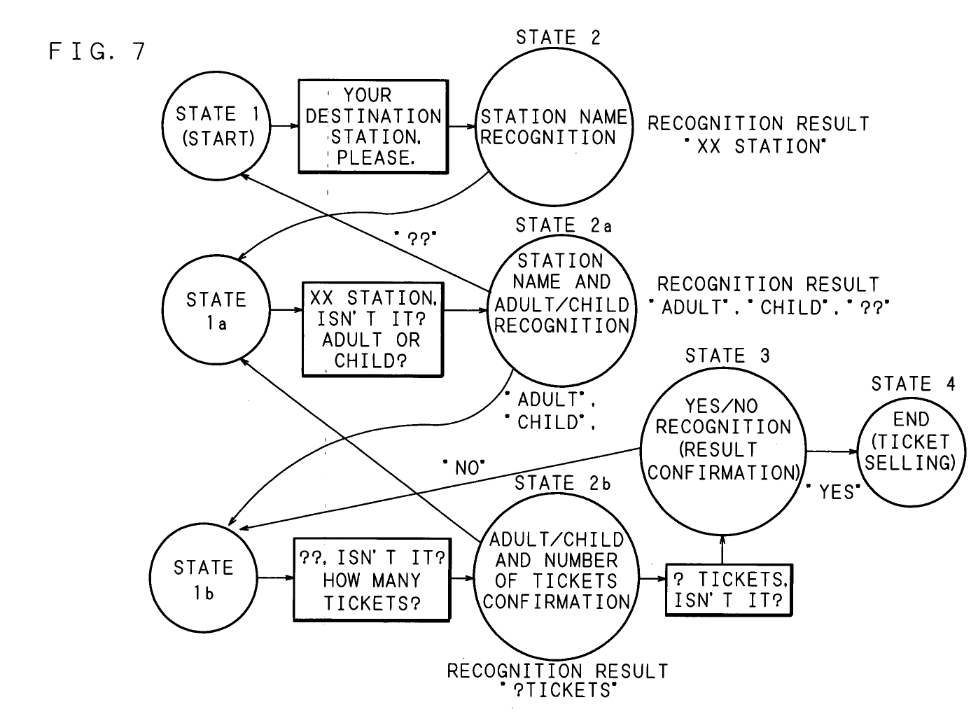

FIG. 7 is a diagram illustrating state transitions in a dialogue scenario for the purchase of a ticket. As shown in FIG. 7, this dialogue scenario begins in State 1. A system utterance “Your destination station, please” is output. Then, the state transits to State 2.

In State 2, speech recognition is performed on the input voice so that the speech recognition result is stored into the RAM 13. Then, the state transits to State 1a. When the stored speech recognition result is “XX station”, in this dialogue scenario, a system utterance “XX station, isn't it?” and a system utterance “Adult or child?” are output. Then, the state transits to State 2a.

In State 2a, speech recognition is performed on the input voice so that the speech recognition result is stored into the RAM 13. When the speech recognition result is “□□” which is neither “Adult” nor “Child”, the state transits to State 1. As such, when a state transition goes backward in the dialogue scenario information, it is judged that the speech recognition result in State 2 or State 2a is not correct. This criterion of the judgment may be changed, for example, into that only when a state transition going backward in the dialogue scenario information occurs successively in the same portion, the speech recognition result is judged to be incorrect.

Alternatively, the number of times of correction of the speech recognition result may be accumulated on the basis of the state transition history. Then, whether the speech recognition result is the correct or not may be judged on the basis of the value of the accumulated number. In FIG. 7, when the speech recognition result in State 2a is “adult” or “child”, the state transits to State 1b. A system utterance “Adult, isn't it?” or “Child, isn't it?” is output. Then, a system utterance “How many tickets?” is output. Then, the state transits to State 2b.

In State 2b, speech recognition is performed on the input voice so that the speech recognition result is stored into the RAM 13. When the speech recognition result is “□”, a system utterance “□ tickets, isn't it?” is output. Then, the state transits to State 3.

In State 3, speech recognition is performed on the input voice so that the speech recognition result is stored into the RAM 13. In State 3, the speech recognition result is expected to be the alternative of “Yes” or “No”. Thus, a high reliability is obtained in the speech recognition result in State 3. When the stored speech recognition result is “No”, the state transits to State 1b. Then, an utterance for requiring the re-input of the number of tickets is output so that the speech recognition result is corrected.

As such, the number of times of correction of the speech recognition result is accumulated, so that when the accumulated number is smaller than a predetermined value, the speech recognition result is judged to be correct. That is, when the number of times of correction of the speech recognition result by the speaking person is small, it is judged that the speech recognition engine outputs correct recognition results. And hence, it is judged that the dialogue is established meaningfully according to dialogue scenario information.

As described above, according to Embodiment 1, when an operator or the like serving as a third party finds stagnation in a dialogue performed between a user and the system, an error in the recognition for the utterance generated immediately before the user has suspended the dialogue can be corrected. Thus, on the basis of the correct recognition result, the dialogue can be resumed according to the dialogue scenario. This prevents the operator from being restrained to a single dialogue, and allows the operator to assist stagnated dialogues solely so as to correct the misrecognition. This permits easy restoration of the dialogue into line with the dialogue scenario, and hence allows the dialogue to advance effectively without a sense of discomfort to users.

Further, even when it is difficult to judge that the recognition is mistaken, it can be detected whether the dialogue is stagnating or not, on the basis of the state transition history of the dialogue. This permits more accurate judgment whether the dialogue is advancing or not between a user and the dialogue system.

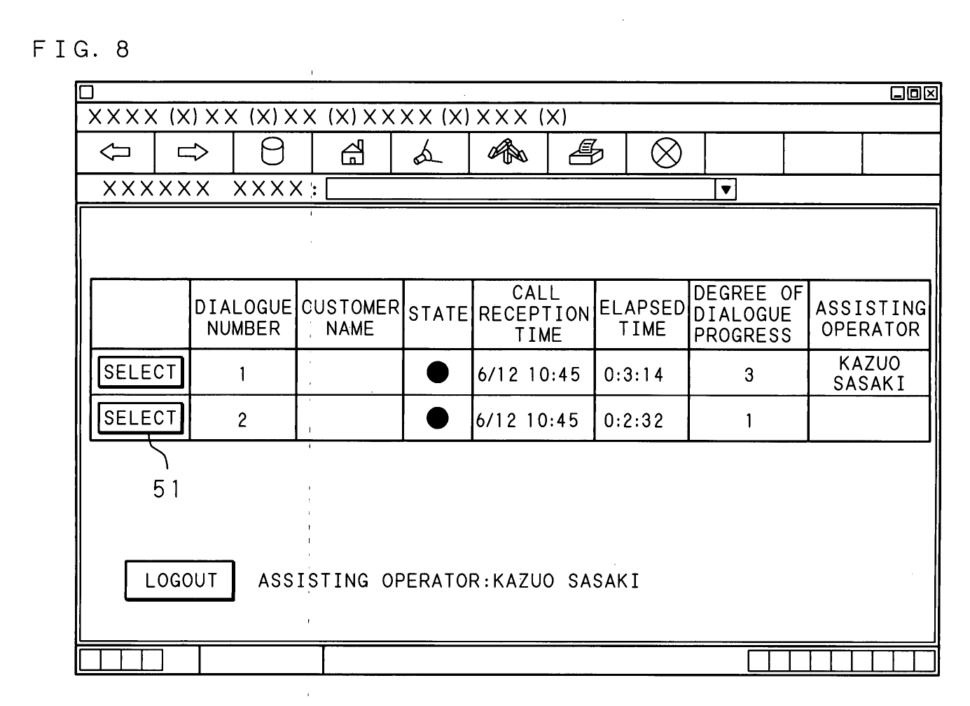

On the other hand, in addition to that the situation of a dialogue error is displayed, it is preferable to judge and display also the degree of progress of the dialogue, the type of the dialogue, and the like. FIG. 8 is a diagram illustrating another example of a dialogue monitor screen for displaying a dialogue state in the case that the degree of progress of the dialogue is judged and displayed.

As shown in FIG. 8, dialogues performed between users and the automatic answering system 10 are displayed such that the state of each dialogue is shown with a number for identifying the dialogue. Specifically, displayed are: the name of each customer in dialogue execution; the state of the dialogue; the start time of the dialogue; and the elapsed time after the dialogue start; as well as the calculated value of the degree of dialogue progress.

The degree of dialogue progress is calculated, for example, by the following method. When a dialogue scenario stored in the dialogue scenario information 121 is described, a count instruction is described in each of the following three positions: the beginning of the dialogue scenario; the end of the introductory stage of the dialogue scenario (the beginning of the middle stage of the dialogue scenario); and the end of the middle stage of the dialogue scenario (the beginning of the final stage of the dialogue scenario). When the dialogue between the user and the automatic answering system 10 advances according to the dialogue scenario information 121, a counter for each dialogue number provided in the RAM 13 is incremented by ‘1’ in response to each count instruction. Accordingly, when the dialogue is started, the counter value is ‘1’. Thus, it is judged that the dialogue is in the introductory stage. When the introductory stage of the dialogue scenario is completed, the counter value is ‘2’. Thus, it is judged that the dialogue is in the middle stage. When the middle stage of the dialogue scenario is completed, the counter value is ‘3’. Thus, it is judged that the dialogue is in the final stage.

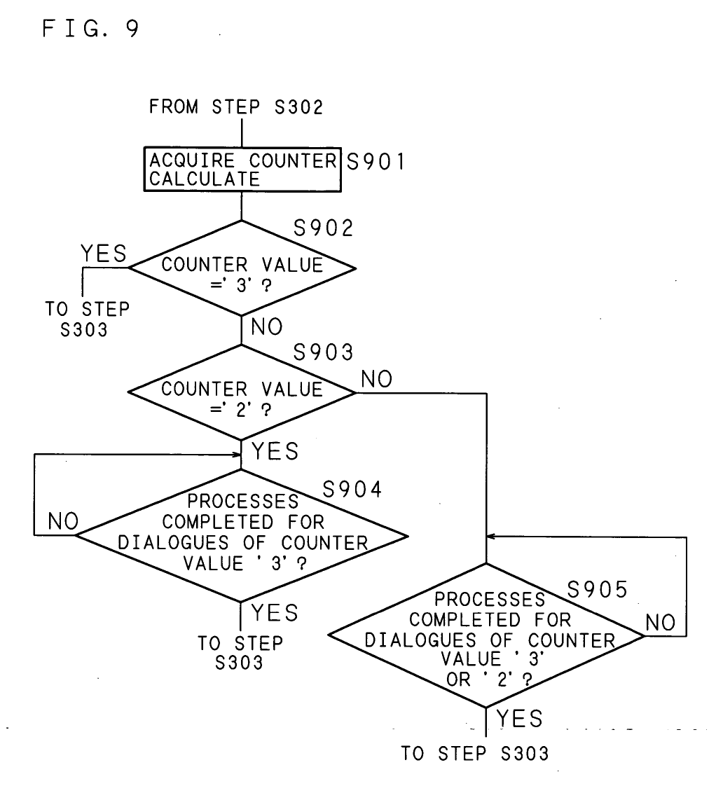

The CPU 41 monitors the dialogue between the user and the automatic answering system 10. When judging that the dialogue is stagnating, the CPU 41 assists the dialogue by means of intervention by an operator serving as a third party. FIG. 9 is a flow chart showing a procedure of the CPU 41 of the dialogue assistance apparatus 40 of the voice dialogue system according to Embodiment 1 of the invention.

When it is judged that the dialogue between the user and the automatic answering system 10 is not established meaningfully in Step S302 of FIG. 3 (Step S302: NO), the CPU 41 acquires a counter value for the corresponding dialogue number from the counter stored in the RAM 13 of the automatic answering system 10 (Step S901). The CPU 41 judges whether the acquired counter value is ‘3’ or not (Step S902). When the CPU 41 judges that the acquired counter value is ‘3’ (Step S902: YES), the CPU 41 returns the process to Step S303.

When the CPU 41 judges that the acquired counter value is not ‘3’ (Step S902: NO), the CPU 41 judges whether the acquired counter value is ‘2’ or not (Step S903). When the CPU 41 judges that the acquired counter value is ‘2’ (Step S903: YES), the CPU 41 judges whether all the dialogue assistance processes for dialogues having a counter value of ‘3’ have been completed or not (Step S904).

When the CPU 41 judges that all the dialogue assistance processes for dialogues having a counter value of ‘3’ have been completed (Step S904: YES), the CPU 41 returns the process to Step S303.

When the CPU 41 judges that the acquired counter value is not ‘2’ (Step S903: NO), the CPU 41 judges whether all the dialogue assistance processes for dialogues having a counter value of ‘3’ or ‘2’ have been completed or not (Step S905).

When the CPU 41 judges that whether all the dialogue assistance processes for dialogues having a counter value of ‘3’ or ‘2’ have been completed (Step S905: YES), the CPU 41 returns the process to Step S303.

The above-mentioned procedure has been described for the case that the dialogue scenario is divided into three stages of the introductory stage, the middle stage, and the final stage so that the degree of dialogue progress is obtained from the counter value. However, the number of division is not limited to three. As long as the degree of dialogue progress is obtained from the counter value, the dialogue scenario may be divided into another number of stages.

Further, the method used is not limited to the method of acquiring the degree of dialogue progress from the counter value. For example, the number of state transitions may be counted so that the degree of dialogue progress may be evaluated on from the value of the number of transitions. Alternatively, the degree of dialogue progress may be evaluated from the size of the utterance data input by the user. Further, the degree of dialogue progress may be evaluated from the length of the elapsed dialogue time after the dialogue begins.

Accordingly, when a plurality of dialogue errors occur, information allowing the operator to judge the priority of the dialogue errors to be processed is provided on the basis of another information other than the dialogue errors. This allows the operator to judge the appropriate order of processing and answering the dialogue errors effectively.

As for the type of the dialogue, predetermined tags or the like are provided in the dialogue scenario. That is, the value of each tag is recorded in a manner corresponded to each page type, such as a page of mere information reference and a page of purchase submission. When a dialogue error occurs, the type of the dialogue performed in the page where the dialogue error occurs can be distinguished by acquiring the value of the tag.

Accordingly, when the display screen to the operator is changed depending on the value of the tag, a user who has an intention of purchasing goods can be served with priority over a user presently in information reference.

The order of dialogues to be assisted is not limited to be set up on the basis of the degree of dialogue progress. The order may be set up together with another additional condition. For example, priority may be set up in the dialogue scenario. Alternatively, priority may be determined depending on the importance of the utterance data input by the user. Further, in an example of a control method, a dialogue assistance history in the past may be stored for each dialogue scenario. Then, a dialogue which uses a dialogue scenario frequently requiring dialogue assistance may be assisted with high priority. In another example of a control method, a dialogue assistance history in the past may be stored for each user. Then, the dialogue of a user frequently receiving dialogue assistance may be assisted with high priority. The measure of the degree of frequently requiring dialogue assistance is not limited to a specific one. The measure used may be: the dialogue time length; the number of times of use of a dialogue scenario; the total number of times of assistance in the past; or the ratio of the number of times of assistance to the number of times of use.

### EMBODIMENT 2

A block diagram showing the configuration of a voice dialogue system according to Embodiment 2 of the invention is the same as that of FIGS. 1 and 2. In Embodiment 1 described above, the state of a dialogue was discriminated by a color displayed on the dialogue monitor screen shown in FIG. 5. For example, when a dialogue was performed normally, the dialogue was displayed in blue. When the progress of a dialogue was slow, the dialogue was displayed in yellow. When a dialogue was stagnating, the dialogue was displayed in red. The present Embodiment 2 is characterized in that the criteria can be changed in the judgments whether the dialogue is performed normally or not, whether the progress of the dialogue is slow or not, and whether the dialogue is stagnating or not.

The degree of dialogue progress is calculated, for example, by the following method. When a dialogue scenario stored in the dialogue scenario information 121 is described, a count instruction is described in each of the following three positions: the beginning of the dialogue scenario; the end of the introductory stage of the dialogue scenario; and the end of the middle stage of the dialogue scenario. When the dialogue between the user and the automatic answering system 10 advances according to the dialogue scenario information 121, a counter for each dialogue number provided in the RAM 13 is incremented by ‘1’ in response to each count instruction. Accordingly, when the dialogue is started, the counter value is ‘1’. Thus, it is judged that the dialogue is in the introductory stage. When the introductory stage of the dialogue scenario is completed, the counter value is ‘2’. Thus, it is judged that the dialogue is in the middle stage. When the middle stage of the dialogue scenario is completed, the counter value is ‘3’. Thus, it is judged that the dialogue is in the final stage. In the following description, the count value is used as the degree of dialogue progress P.

When a dialogue error occurs, the error level E of the occurred dialogue error is quantified by the following method. That is, the number of times that the same utterance was performed in the dialogue scenario, the number of times of the occurrence of a dialogue loop, and the like are extracted from the state transition history information 122. Then, the error level is calculated using a predetermined function. For example, the number of times that the same utterance was performed in the dialogue scenario is denoted by N1, while the number of times of the occurrence of a dialogue loop is denoted by N2. Further, evaluation functions for these quantities are denoted by f1(n) and f2(n) (n is a natural number). The error level E is calculated using (Formula 1). The error level E is higher when its value is larger. At that time, it is judged that assistance is necessary with higher priority.
E=f1(N1)+f2(N2) (Formula 1)

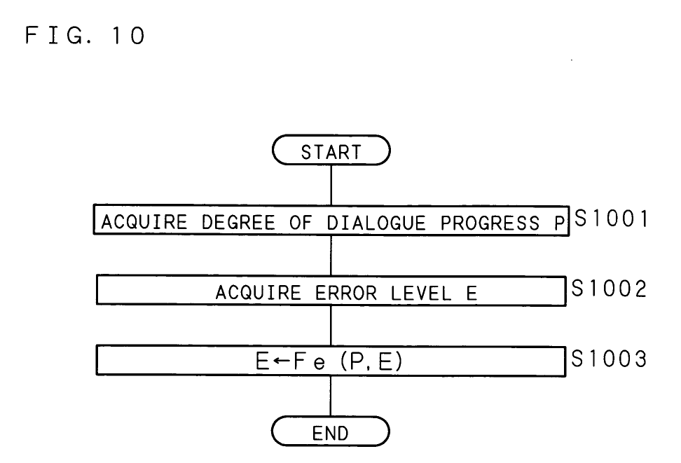

FIG. 10 is a flow chart showing a procedure of the CPU 41 of the dialogue assistance apparatus 40 of the voice dialogue system according to Embodiment 2 of the invention. In the description in FIG. 10, the criterion for the judgment whether the dialogue is performed normally or not is changed into the degree of dialogue progress.

The CPU 41 of the dialogue assistance apparatus 40 reads the counted value stored in the RAM 13, and acquires the degree of dialogue progress P (Step S1001). Further, the CPU 41 acquires from the RAM 13 the stored error level E of the occurred dialogue error (Step S1002).

The CPU 41 updates the acquired error level E according to the acquired degree of dialogue progress P. That is, using an error level update function Fe(x, y) (x is the degree of dialogue progress, while y is the error level), the CPU 41 calculates the updated error level E according to (Formula 2) (Step S1003).
E=Fe(P, E) (Formula 2)

The error level update function Fe (x, y) is not limited to a specific one. For example, the function may be one adding the value of the degree of dialogue progress P to the value of the error level E. Alternatively, the function may be one provided with a table where the value of the error level E is changed stepwise depending on the value of the degree of dialogue progress P.

On the basis of the calculated error level E, the CPU 41 judges whether the dialogue is performed normally or not. In the present embodiment, the value of the criterion for the judgment whether the dialogue is performed normally or not is set up such as to go higher when the degree of dialogue progress P goes higher, that is, when that the dialogue is in a further progressed state.

In the example described above, the criterion for the judgment whether the dialogue is performed normally or not is changed depending on the degree of dialogue progress. Such change can be made similarly also for the judgments whether the progress of the dialogue is slow or not and whether the dialogue is stagnating or not. Further, such change is not limited to be made depending on the degree of dialogue progress. For example, the criterion of the judgment may be changed depending on the type of the dialogue.

Accordingly, the criterion for the judgment whether the dialogue is performed normally or not, the criterion for the judgment whether the progress of the dialogue is slow or not, and the criterion for the judgment whether the dialogue is stagnating or not can be changed dynamically depending on the degree of dialogue progress, the type of the dialogue, and the like. This provides dialogue assistance adapted more appropriately to actual conditions.

The changing of the error level is not limited to addition based on another condition or the like. For example, the error level may first be set at the maximum regardless of the kind of the error. Then, a value may be subtracted depending on another condition.

### EMBODIMENT 3

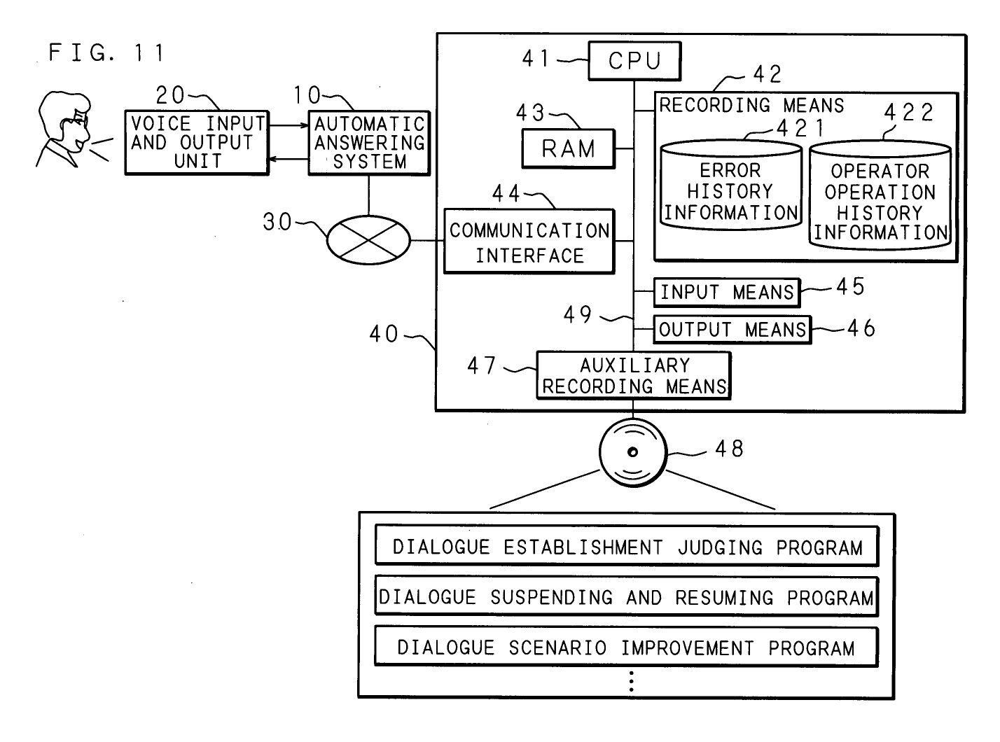

FIG. 11 is a block diagram showing the configuration of a voice dialogue system according to Embodiment 3 of the invention. The configuration of the voice dialogue system according to Embodiment 3 is basically the same as that of Embodiment 1. Thus, the same numerals are used so that detailed description is omitted. The dialogue assistance apparatuses 40 of the voice dialogue system according to Embodiment 3 of the invention comprises at least: a CPU (central processing unit) 41; recording means 42; a RAM 43; a communication interface 44 connected to external communication means such as a network 30; input means 45; output means 46; and auxiliary recording means 47 employing a portable recording media 48 such as a DVD and a CD.

The CPU 41 is connected to each part of the above-mentioned hardware of the dialogue assistance apparatus 40 via an internal bus 49, and thereby controls each part of the above-mentioned hardware. Then, the CPU 41 performs various software functions according to processing programs recorded in the recording means 42. These programs include: a program for judging whether a dialogue is established meaningfully or not; a program for suspending or resuming the dialogue; and a program for updating dialogue scenario information according to an error.

The recording means 42 is composed of a built-in fixed mount type recording unit (hard disk), a ROM, or the like. The recording means stores the processing programs necessary for the function of the dialogue assistance apparatus 40 which are acquired from a computer in the outside via the communication interface 44, or from the portable recording media 48 such as a DVD and a CD-ROM. In addition to the processing program, the recording means 42 records: error history information 421 for recording a portion where an error occurs in the dialogue scenario and the contents of the error; operator operation history information 422 for recording the history of assistance operation performed by an operator; and the like.

The CPU 41 of the dialogue assistance apparatus 40 refers to the error history information 421 and the operator operation history information 422 at arbitrary time points, and thereby performs statistical analysis so as to specify a portion having a high probability that an error occurs in the dialogue scenario. Then, the CPU 41 calculates: the similarity of operation of the operator in the error occurrence portion; the operation generation frequency for each operator operation; and the like, and then records the data into the recording means 42. Then, as for a portion where the operation generation frequency for each operator operation exceeds a predetermined threshold, it is judged that a certain problem is inherent in the dialogue scenario. Then, the error occurrence portion and the operator operation are presented to an operator or a manager of the automatic answering system operation of.

For example, as for a dialogue error that an utterance is performed in a predetermined portion of the dialogue scenario, in case that the operator has selected multiple times a candidate for the same contents of the response, the candidates for the contents of the response are presented in the descending order of the number of times of selection as the response. This clarifies the necessity of the renewal of the dialogue scenario, for example, when the expected contents of the response described in the dialogue scenario are insufficient. Alternatively, the candidates for the contents of the response may automatically be added to the corresponding portion of the dialogue scenario.

Accordingly, dialogue errors caused by inappropriateness in the dialogue scenario itself can be reduced. This provides a voice dialogue system causing less sense of discomfort to the user.

In the Embodiments 1 through 3 described above, in place that a stagnated dialogue is simply displayed on a dialogue monitor screen, the screen display may be carried out along the dialogue scenario used in the stagnated portion of the dialogue. This clarifies the portion where the misrecognition occurs in the dialogue scenario, and hence permits more effective dialogue assistance.

The Embodiments 1 through 3 described above have been described for the case of an automatic answering system using voice. However, the automatic answering system is not limited to one using voice. Another means may be used that permits a dialogue between the automatic answering system and the user. For example, input and output means may be adopted that uses characters (text data), images, or the like.

In case that the dialogue is performed by means of input and output of characters, the voice input and output unit 20 is replaced by a character input and output unit such as a keyboard and a display unit. In the dialogue scenario information 121 in the automatic answering system 10, the contents of the dialogue is described not in VXML but in a description form suitable for the input and output of characters.

In this automatic answering system, on the basis of a dialogue scenario, using a chat system or the like, a query statement in the dialogue scenario is transmitted and displayed on a user's display unit. The user inputs a response to the query using the chat system. The automatic answering system compares the input reply with the contents of the reply expected in the dialogue scenario. When a reply expected as a response is present, it is judged that the dialogue is established meaningfully. Then, the procedure goes to the next process according to the dialogue scenario. When no reply expected as a response is present, it is judged as a dialogue error. Then, the question is presented again, so that the re-input of the response is prompted. The situation of the dialogue is monitored or recorded successively.

Accordingly, similarly to the case of the voice system, the monitoring of dialogue errors, the display of the dialogue situation, the assistance of a dialogue, and the like can be performed.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A dialogue system comprising:
means for receiving an utterance;
means for recognizing the received utterance;
means for advancing a dialogue on the basis of the recognized result and dialogue scenario information which describes a procedure for advancing the dialogue;
means for outputting a response to said received utterance; and
a dialogue assistance apparatus connected in a state permitting transmission and reception of data via communication means, and
the dialogue assistance apparatus comprises:
dialogue establishment judging means for judging whether the dialogue is established meaningfully or not;
dialogue suspending means for suspending said dialogue when the dialogue establishment judging means judges that said dialogue is not established meaningfully;
means for displaying a plurality of recognition candidates for an utterance received last in the dialogue suspended by the dialogue suspending means;
means for receiving one recognition candidate selected from a plurality of said recognition candidates displayed by the means; and
means for sending out the received one recognition candidate; and wherein
the system further comprises
means for resuming the dialogue according to said dialogue scenario information starting at the portion having been suspended, when said one recognition candidate is received from said dialogue assistance apparatus.

2. A dialogue system according to claim 1, wherein
the dialogue establishment judging means comprises:
dialogue history storage means for storing a state transition history of a dialogue based on said dialogue scenario information; and
misrecognition judging means for judging whether said received utterance has been recognized incorrectly or not on the basis of said recognized result and said state transition history.

3. A dialogue system according to claim 2, wherein
the misrecognition judging means comprises
means for judging whether any portion of said dialogue scenario information is repeated in said state transition history or not, and wherein
when the means has judged that a portion is repeated, it is judged that said received utterance has been recognized incorrectly.

4. A dialogue system according to claim 1 in case that a plurality of dialogues are on going on the basis of a plural pieces of said dialogue scenario information, further comprising:
means for calculating a degree of dialogue progress which indicates a degree of progress of each of said dialogues; and
priority calculating means for calculating a priority for each of said dialogues on the basis of a condition including said degree of dialogue progress.

5. A dialogue system according to claim 2 in case that a plurality of dialogues are on going on the basis of a plural pieces of said dialogue scenario information, further comprising:
means for calculating a degree of dialogue progress which indicates a degree of progress of each of said dialogues; and
priority calculating means for calculating a priority for each of said dialogues on the basis of a condition including said degree of dialogue progress.

6. A dialogue system according to claim 3 in case that a plurality of dialogues are on going on the basis of a plural pieces of said dialogue scenario information, further comprising:
means for calculating a degree of dialogue progress which indicates a degree of progress of each of said dialogues; and
priority calculating means for calculating a priority for each of said dialogues on the basis of a condition including said degree of dialogue progress.

7. A dialogue system comprising a processor capable of performing the following operations of:
receiving an utterance;
recognizing the received utterance;
advancing a dialogue on the basis of the recognized result and dialogue scenario information which describes a procedure for advancing the dialogue; and
outputting a response to said received utterance; wherein
the system comprises
a dialogue assistance apparatus connected in a state permitting transmission and reception of data via communication means, and
the dialogue assistance apparatus comprising a processor capable of performing the following operations of:
judging whether the dialogue is established meaningfully or not;
suspending said dialogue when it is judged that said dialogue is not established meaningfully;
displaying a plurality of recognition candidates for an utterance received last in the dialogue suspended by the dialogue suspending means;
receiving one recognition candidate selected from a plurality of said displayed recognition candidates; and
sending out the received one recognition candidate; and wherein
the system comprises a processor further capable of performing the operations of
resuming the dialogue according to said dialogue scenario information starting at the portion having been suspended, when said one recognition candidate is received from said dialogue assistance apparatus.

8. A dialogue system according to claim 7, wherein
the dialogue assistance apparatus comprises a processor further capable of performing the operations of:
storing a state transition history of a dialogue based on said dialogue scenario information; and
judging whether said received utterance has been recognized incorrectly or not on the basis of said recognized result and said state transition history.

9. A dialogue system according to claim 8, wherein
the dialogue assistance apparatus comprises a processor further capable of performing the operation of
judging whether any portion of said dialogue scenario information is repeated in said state transition history or not, and wherein
when a portion is judged to be repeated, it is judged that said received utterance has been recognized incorrectly.

10. A dialogue system according to claim 7 in case that a plurality of dialogues are on going on the basis of a plural pieces of said dialogue scenario information, comprising a processor further capable of performing the following operations of:
calculating a degree of dialogue progress which indicates a degree of progress of each of said dialogues; and
calculating a priority for each of said dialogues on the basis of a condition including said degree of dialogue progress.

11. A dialogue system according to claim 8 in case that a plurality of dialogues are on going on the basis of a plural pieces of said dialogue scenario information, comprising a processor further capable of performing the following operations of:
calculating a degree of dialogue progress which indicates a degree of progress of each of said dialogues; and
calculating a priority for each of said dialogues on the basis of a condition including said degree of dialogue progress.

12. A dialogue system according to claim 9 in case that a plurality of dialogues are on going on the basis of a plural pieces of said dialogue scenario information, comprising a processor further capable of performing the following operations of:
calculating a degree of dialogue progress which indicates a degree of progress of each of said dialogues; and
calculating a priority for each of said dialogues on the basis of a condition including said degree of dialogue progress.

13. A dialogue assistance apparatus comprising:
means for receiving an utterance;
means for recognizing the received utterance;
means for advancing a dialogue on the basis of the recognized result and dialogue scenario information which describes a procedure for advancing the dialogue; and
means for outputting a response to said received utterance; wherein
the dialogue assistance apparatus comprises:
dialogue establishment judging means for judging whether the dialogue is established meaningfully or not;
dialogue suspending means for suspending said dialogue when the dialogue establishment judging means judges that said dialogue is not established meaningfully;
means for displaying a plurality of recognition candidates for an utterance received last in the dialogue suspended by the dialogue suspending means;
means for receiving one recognition candidate selected from a plurality of said recognition candidates displayed by the means; and
means for sending out the received one recognition candidate.

14. A dialogue assistance apparatus according to claim 13, wherein
the dialogue establishment judging means comprises:
dialogue history storage means for storing a state transition history of a dialogue based on said dialogue scenario information; and
misrecognition judging means for judging whether said received utterance has been recognized incorrectly or not on the basis of said recognized result and said state transition history.

15. A dialogue assistance apparatus according to claim 14, wherein
the misrecognition judging means comprises
means for judging whether any portion of said dialogue scenario information is repeated in said state transition history or not, and wherein
when the means has judged that a portion is repeated, it is judged that said received utterance has been recognized incorrectly.

16. A dialogue assistance apparatus according to claim 13 in case that a plurality of dialogues are on going on the basis of a plural pieces of said dialogue scenario information, comprises:
means for calculating a degree of dialogue progress which indicates a degree of progress of each of said dialogues; and
priority calculating means for calculating a priority for each of said dialogues on the basis of a condition including said degree of dialogue progress.

17. A dialogue assistance apparatus according to claim 14 in case that a plurality of dialogues are on going on the basis of a plural pieces of said dialogue scenario information, comprises:
means for calculating a degree of dialogue progress which indicates a degree of progress of each of said dialogues; and
priority calculating means for calculating a priority for each of said dialogues on the basis of a condition including said degree of dialogue progress.

18. A dialogue assistance apparatus according to claim 15 in case that a plurality of dialogues are on going on the basis of a plural pieces of said dialogue scenario information, comprises:
means for calculating a degree of dialogue progress which indicates a degree of progress of each of said dialogues; and
priority calculating means for calculating a priority for each of said dialogues on the basis of a condition including said degree of dialogue progress.

19. A dialogue assistance apparatus comprising a processor capable of performing the following operations of
receiving an utterance;
recognizing the received utterance;
advancing a dialogue on the basis of the recognized result and dialogue scenario information which describes a procedure for advancing the dialogue; and
outputting a response to said received utterance; wherein
the dialogue assistance apparatus comprising a processor capable of performing the following operations of:
judging whether the dialogue is established meaningfully or not;
suspending said dialogue when it is judged that said dialogue is not established meaningfully;
displaying a plurality of recognition candidates for an utterance received last in the dialogue suspended by the dialogue suspending means;
receiving one recognition candidate selected from a plurality of said displayed recognition candidates; and
sending out the received one recognition candidate.

20. A dialogue assistance apparatus according to claim 19, comprising a processor further capable of performing the following operations of:
storing a state transition history of a dialogue based on said dialogue scenario information; and
judging whether said received utterance has been recognized incorrectly or not on the basis of said recognized result and said state transition history.

21. A dialogue assistance apparatus according to claim 20, comprising a processor further capable of performing the following operation of
judging whether any portion of said dialogue scenario information is repeated in said state transition history or not, wherein
when a portion is judged to be repeated, it is judged that said received utterance has been recognized incorrectly.

22. A dialogue assistance apparatus according to claim 19 in case that a plurality of dialogues are on going on the basis of a plural pieces of said dialogue scenario information, comprising a processor further capable of performing the following operations of:
calculating a degree of dialogue progress which indicates a degree of progress of each of said dialogues; and
calculating a priority for each of said dialogues on the basis of a condition including said degree of dialogue progress.

23. A dialogue assistance apparatus according to claim 20 in case that a plurality of dialogues are on going on the basis of a plural pieces of said dialogue scenario information, comprising a processor further capable of performing the following operations of:
calculating a degree of dialogue progress which indicates a degree of progress of each of said dialogues; and
calculating a priority for each of said dialogues on the basis of a condition including said degree of dialogue progress.

24. A dialogue assistance apparatus according to claim 21 in case that a plurality of dialogues are on going on the basis of a plural pieces of said dialogue scenario information, comprising a processor further capable of performing the following operations of:
calculating a degree of dialogue progress which indicates a degree of progress of each of said dialogues; and
calculating a priority for each of said dialogues on the basis of a condition including said degree of dialogue progress.

25. A dialogue method comprising the steps of:
receiving an utterance;
recognizing the received utterance;
advancing a dialogue on the basis of the recognized result and dialogue scenario information which describes a procedure for advancing the dialogue; and
outputting a response to said received utterance; wherein
the method comprises the following steps of:
judging whether the dialogue is established meaningfully or not;
suspending said dialogue when it is judged that said dialogue is not established meaningfully;
displaying a plurality of recognition candidates for an utterance received last in the dialogue suspended by the dialogue suspending means;
receiving one recognition candidate selected from a plurality of said displayed recognition candidates; and
resuming the dialogue according to said dialogue scenario information starting at the portion having been suspended, when said one recognition candidate is received.

26. A dialogue method according to claim 25, comprising the following steps of:
storing a state transition history of a dialogue based on said dialogue scenario information; and
judging whether said received utterance has been recognized incorrectly or not on the basis of said recognized result and said state transition history.

27. A dialogue method according to claim 26, comprising the following steps of:
judging whether any portion of said dialogue scenario information is repeated in said state transition history or not; and
judging that said received utterance has been recognized incorrectly, in case that a portion is judged to be repeated.

28. A dialogue method according to claim 25 in case that a plurality of dialogues are on going on the basis of a plural pieces of said dialogue scenario information, comprising the following steps of:
calculating a degree of dialogue progress which indicates a degree of progress of each of said dialogues; and
calculating a priority for each of said dialogues on the basis of a condition including said degree of dialogue progress.

29. A dialogue method according to claim 26 in case that a plurality of dialogues are on going on the basis of a plural pieces of said dialogue scenario information, comprising the following steps of:
calculating a degree of dialogue progress which indicates a degree of progress of each of said dialogues; and
calculating a priority for each of said dialogues on the basis of a condition including said degree of dialogue progress.

30. A dialogue method according to claim 27 in case that a plurality of dialogues are on going on the basis of a plural pieces of said dialogue scenario information, comprising the following steps of:
calculating a degree of dialogue progress which indicates a degree of progress of each of said dialogues; and
calculating a priority for each of said dialogues on the basis of a condition including said degree of dialogue progress.

31. A recording medium storing a computer program comprises the steps of:
causing a computer to receive an utterance;
causing a computer to recognize the received utterance;
causing a computer to advance a dialogue on the basis of the recognized result and dialogue scenario information which describes a procedure for advancing the dialogue; and
causing a computer to output a response to said received utterance; wherein
the computer program comprises the steps of:
causing a computer to judge whether the dialogue is established meaningfully or not;
causing a computer to suspend said dialogue when it is judged that said dialogue is not established meaningfully;
causing a computer to display a plurality of recognition candidates for an utterance received last in the dialogue suspended by the dialogue suspending means;
causing a computer to receive one recognition candidate selected from a plurality of said displayed recognition candidates; and
causing a computer to send out the received one recognition candidate.

32. A recording medium according to claim 31, storing a computer program further comprising the steps of:
causing a computer to store a state transition history of a dialogue based on said dialogue scenario information; and
causing a computer to judge whether said received utterance has been recognized incorrectly or not on the basis of said recognized result and said state transition history.

33. A recording medium according to claim 32, storing a computer program further comprising the step of
causing a computer to judge whether any portion of said dialogue scenario information is repeated in said state transition history or not, wherein
when a portion is judged to be repeated, it is judged that said received utterance has been recognized incorrectly.

34. A recording medium according to claim 31, storing a computer program in case that a plurality of dialogues are on going on the basis of a plural pieces of said dialogue scenario information, further comprising the steps of:
causing a computer to calculate a degree of dialogue progress which indicates a degree of progress of each of said dialogues; and
causing a computer to calculate a priority for each of said dialogues on the basis of a condition including said degree of dialogue progress.

35. A recording medium according to claim 32, storing a computer program in case that a plurality of dialogues are on going on the basis of a plural pieces of said dialogue scenario information, further comprising the steps of:
causing a computer to calculate a degree of dialogue progress which indicates a degree of progress of each of said dialogues; and
causing a computer to calculate a priority for each of said dialogues on the basis of a condition including said degree of dialogue progress.

36. A recording medium according to claim 33, storing a computer program in case that a plurality of dialogues are on going on the basis of a plural pieces of said dialogue scenario information, further comprising the steps of:
causing a computer to calculate a degree of dialogue progress which indicates a degree of progress of each of said dialogues; and
causing a computer to calculate a priority for each of said dialogues on the basis of a condition including said degree of dialogue progress.
